(19) United States
(12) Patent Application Publication
(10) Pub. No.: US 2007/0080943 A1
(43) Pub. Date: Apr. 12, 2007

(54) Computer mouse capable of receiving and transmitting voice via the Internet

(76) Inventors: Wen-Han Chang, Taipei City (TW); Chin-Ming Lu, Taipei City (TW)

Correspondence Address: LEONG C LEI, PMB # 1008, 1867 YGNACIO VALLEY ROAD, WALNUT CREEK, CA, 94598, US

(21) Appl. No.: 11/244,181

(22) Filed: Oct. 6, 2005

(51) Int. Cl. G09G 5/08

(52) U.S. Cl. 345/163

(57) ABSTRACT

A computer mouse which includes a circuit board disposed within the body portion, a loudspeaker mounted on the circuit board, a microphone mounted on the circuit board, a switch mounted on the circuit board and extending upwardly out of the body portion, a volume control mounted on the circuit board and extending laterally out of the body portion, an electrical socket mounted on the circuit board, a cable provided with a USB connector, a loudspeaker connector, a microphone connector, and a cable reel connected with the cable, whereby the computer mouse can be used for converting electrical signals into sounds loud enough to be heard at a distance and converting sound waves into electrical energy thereby enabling the user to listen to the music and talk through the computer via the Internet.

### BACKGROUND OF THE INVENTION

1. Field of the Invention

This invention is related to a computer mouse, and in particular to one which can be used for converting electrical signals into sounds loud enough to be heard at a distance and converting sound waves into electrical energy thereby enabling the user to listen to the music and talk through the computer via the Internet.

2. Description of the Prior Art

It has been found that data is input through use of a pointing device that moves a cursor on a computer screen in many computers. The user can select a menu item, highlight a portion of the display, select a screen region for inquiry or other action, select hypertext, or perform numerous other activities by pressing one or more buttons on the pointing device. Such a pointing device is generally referred to as a computer mouse. Hundreds of computer computer mouses have been disclosed since the relatively recent advent of personal computers. Most of them comprises a rotatable ball and one or more buttons which will activate switches when depressed. Electronic sensors and encoders are used to sense ball rotation and generate a signal indicative of the ball's rotation. Generally two basic types of rotating ball systems are used and the most common is confined in the lower portion of the mouse where the ball rests on a flat surface. Movement of the mouse on the flat surface causes rotation of the ball and a “trackball” has been developed to present the ball directly to the user's thumb or fingers for rotation. In the “trackball” approach, the computer mouse does not have to be moved and only the ball rotated within the mouse housing.

The computer mouse is molded to comfortably fit a user's hand and contains internal sensors for detecting, measuring and encoding movement of the mouse across a desktop, mouse pad or other surface. The computer is connected by a cord or a wireless connection to a computer. Generally, a computer mouse has two or more buttons which a user can press to make a selection. Many forms of computer mouse are used or have been proposed for controlling the coordinates of a cursor on the computer screen as the user moves it around on a pad. Nevertheless, the user must buy loudspeakers and microphone in order to listen to music or the like and talk through the Internet thereby increasing the cost. Furthermore, the wires connecting the loudspeakers and microphone to the computer will make the desk a mess.

Therefore, it is an object of the present invention to provide a computer mouse which can be used for converting electrical signals into sounds loud enough to be heard at a distance and converting sound waves into electrical energy thereby enabling the user to listen to the music and talk through the computer via the Internet.

### SUMMARY OF THE INVENTION

According to the present invention, there is provided a computer mouse which includes a circuit board disposed within the body portion, a loudspeaker mounted on the circuit board, a microphone mounted on the circuit board, a switch mounted on the circuit board and extending upwardly out of the body portion, a volume control mounted on the circuit board and extending laterally out of the body portion, an electrical socket mounted on the circuit board, a cable provided with a USB connector, a loudspeaker connector, a microphone connector, and a cable reel connected with the cable, whereby the computer mouse can be used for converting electrical signals into sounds loud enough to be heard at a distance and converting sound waves into electrical energy thereby enabling the user to listen to the music and talk through the computer via the Internet.

It is the primary object of the present invention to provide a computer mouse which can be used for converting electrical signals into sounds loud enough to be heard at a distance.

It is another object of the present invention to provide a computer mouse which can be used for converting sound waves into electrical energy.

It is a further object of the present invention to provide a computer mouse which enables a user to listen to the music and talk through the computer via the Internet.

The foregoing objects and summary provides only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a computer mouse according to the present invention;

FIG. 2 is a perspective view illustrating the bottom side of the computer mouse according to the present invention;

FIG. 3 illustrates the interior structure of the computer mouse according to the present invention;

FIG. 4 is a plan view of a transmission cable according to the present invention;

FIG. 5 is an exploded view of the cable reel according to the present invention;

FIG. 6 is an exploded view of the positioning shaft of the cable reel;

FIG. 7 is a schematic view of the positioning shaft of the cable reel; and

FIG. 8 is a sectional view of the positioning shaft of the cable reel.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

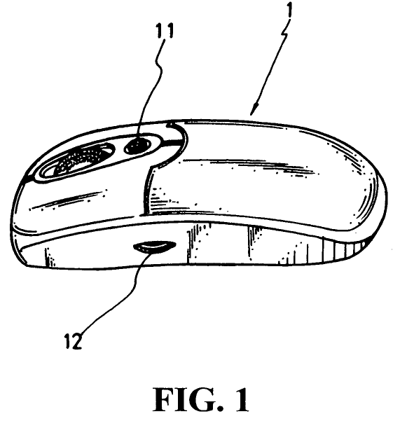

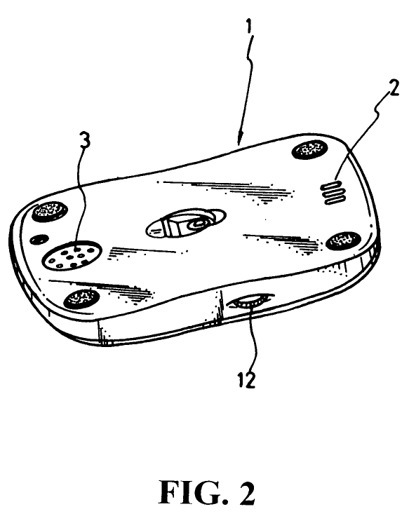

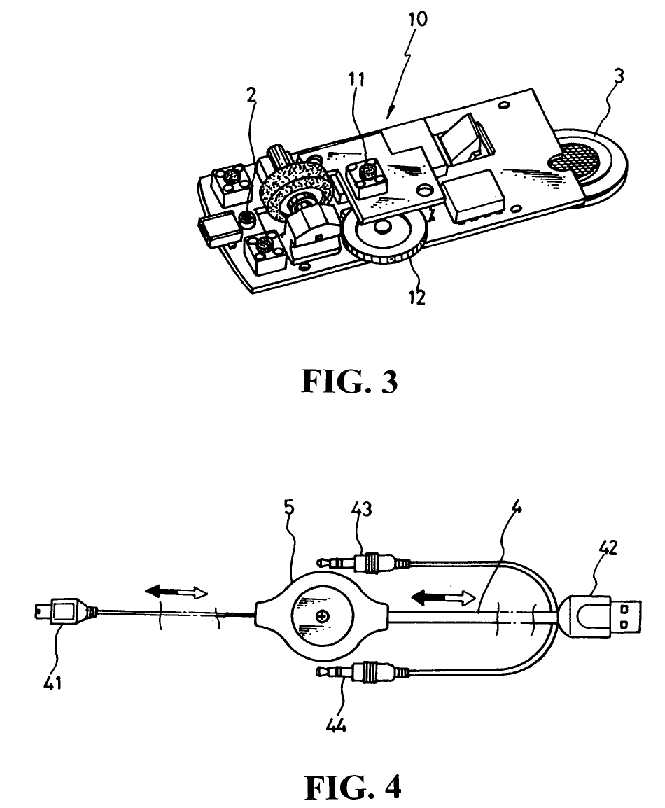

Referring to FIGS. 1, 2 and 3, the computer mouse according to the present invention comprises a body portion (shown but not numbered) in which are mounted a microphone 2 and a loudspeaker 3. The body portion of the computer mouse is further provided with a switch 11 on the top and a volume control 12 at the lateral side. The switch 11, the volume control 12, the microphone 12 and the loudspeaker 3 are arranged on a circuit board 10. The microphone 2 and the switch 11 are mounted on the front portion of the circuit board 10, the loudspeaker 3 is arranged on the rear portion of the circuit board 10, the volume control 12 is disposed on the one side of the circuit board 10, and an electrical socket (shown but not numbered) installed on the circuit board 10. The switch 11 extends upwardly out of the body portion while the volume control 12 extends laterally out of the body portion.

The microphone 2 is used for transmitting voice through a computer (not shown) via the Internet, while the loudspeaker 3 is used for reproducing voice from the computer via the Internet. Hence, the computer mouse can be used for bidirectional communication through the computer via the Internet.

The switch 11 is used for making or breaking the connection of the microphone 2 with the computer. The volume control 12 is used for adjusting the magnitude of sound as desired. The computer mouse is connected with a computer via a transmission cable 4 which comprises a mouse connector 41 adapted to be connected with the electrical socket of the circuit board 10, a USB connector 42, a loudspeaker connector 43, and a microphone connector 44.

FIG. 4 illustrates another preferred embodiment of the transmission cable 4. As illustrated, the transmission cable 4 is connected with a cable reel 5 which is connected to the computer via a connecting wire 41. The transmission cable 4 comprises a mouse connector 41, a USB connector 42, a loudspeaker connector 43 and a microphone connector 44 which are connected with the computer mouse connector (not shown), the loudspeaker connector (not shown) and the microphone connector (not shown) of the computer.

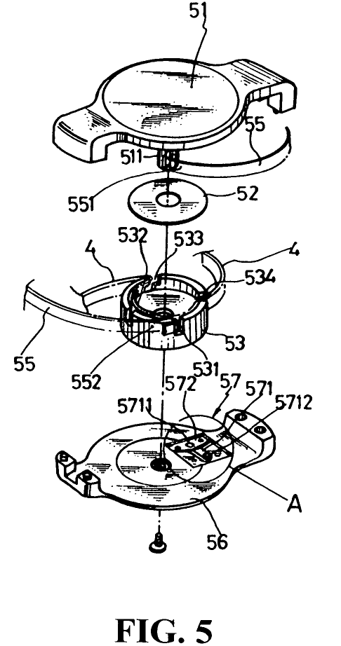

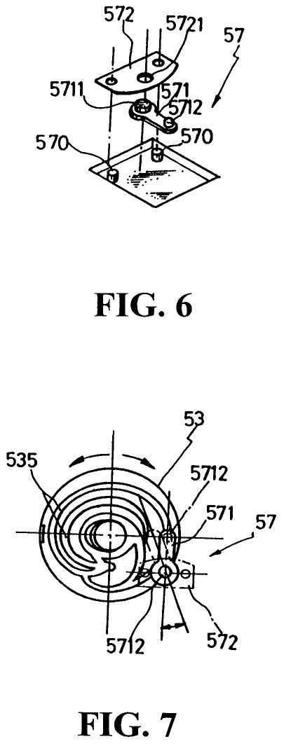

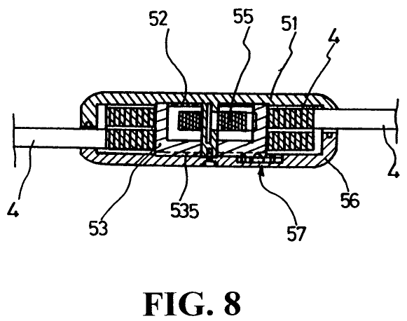

As can be seen in FIGS. 5, 6, 7 and 8, the cable reel 5 of the present invention includes an upper cover 51, a pad 52, a reeling disc 53, a transmission cable 4, a spring 55, a lower cover 56, and a positioning element 57. The inner end 551 of the spring 55 is connected to the engaging slot 511 provided at the center shaft of the upper cover 51, and the outer end 551 of the spring 55 is engaged at the engaging slot 531 of the reeling disc 53 with an edge hook. When the reeling disc 53 rotates clockwise or anti-clockwise, the spring 55 becomes either taut or in loosen condition, and the tautening of the spring 55 provides the power for cable restoration of the cable reel 5.

The edge wall of the reeling disc 53 is a clipping plate 532 which can retract one end of the transmission cable 4 out from the clipping hole 533. The other end of the transmission cable 4 is retracted via a corresponding slit 534 so that the transmission cable 4 with equal length surrounds the upper and lower frame position at the outer edge of the reeling disc 53. When the transmission cable 4 is pulled from dual direction, the transmission cable 4 is pulled at the same time with the same speed, and the transmission cable 4 is further pulled, the transmission cable 4 will be restored to its original position.

The reeling disc 53 and the positioning member 57 at the inner edge of the lower cover 56 form an engaging and disengaging mechanism. The positioning member 57 includes a positioning shaft 571 and a positioning plate 572, and the positioning plate 572 covers the top section of the positioning shaft 571, and the two sides thereof is secured with a peg 570. The positioning plate 572 has a center pivot hole 5721 for pivotal mounting of a pivot 5711 on the positioning shaft 571 so that the positioning shaft 571 forms into a pivotal structure with the positioning plate 572. Additionally, the front end of the exposed positioning plate 572 is provided with a sliding protruded section 5712 corresponding to the railing slot 535 at the bottom section of the reeling disc 53.

The bottom section of the reeling disc 53 is provided with an operational railing slot 535 and the positioning shaft 571 provides an alternating engaging and disengaging action based on the rotating of the railing slot 535. Thus, when the transmission cable 4 is pulled, and the reeling disc 53 is rotating, the positioning shaft 571 together with the operational railing slot 535 forms into a swinging action. This swinging operation retracts the transmission cable 4 and then keeps the cable 4 in position. Another retracting of the transmission cable 4 causes the positioning shaft 571 to disengage. Another subsequent positioning is that after the positioning of the cable 4, before the cable 4 has fully retracted, another retraction of the cable 4 will cause the positioning shaft 571 to proceed to an engagement. Accordingly, the positioning shaft of a dual direction cable reel of the present invention provides a one-time reeling and multiple-stage reeling of cable positioning control.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A computer mouse comprising:
a body portion;
a circuit board disposed within said body portion;
a loudspeaker mounted on said circuit board;
a microphone mounted on said circuit board;
a switch mounted on said circuit board and extending upwardly out of said body portion;
a volume control mounted on said circuit board and extending laterally out of said body portion;
an electrical socket mounted on said circuit board;
a transmission cable provided with a mouse connector, a USB connector, a loudspeaker connector, and a microphone connector, and
a cable reel connected with said cable, said cable reel comprising an upper cover, a pad, a reeling disc, a spring, and a lower cover, said reeling disc and a positioning element being mounted at an inner edge of said lower cover to form an engaging and disengaging mechanism, wherein said positioning element includes a positioning shaft and a positioning plate and said positioning plate covers a top portion of said positioning shaft and is secured with a peg and said positioning plate has a pivot hole at a center thereof for a pivot mounting of said positioning shaft, and a front end of said positioning plate exposed from a shaft body of a positioning shaft is provided with a sliding protruded section corresponding to a railing slot at a bottom section of said reeling disc, and a bottom section is provided with a railing slot for said sliding protruded section to rotate along said reeling slot so as to provide an alternating engaging and a disengaging action.

2. The computer mouse as claimed in claim 1, wherein said microphone is arranged on a front portion of said body portion while said loudspeaker is mounted on a rear portion of said body portion.

3. The computer mouse as claimed in claim 1, wherein said cable has mouse connector, a USB connector, a loudspeaker connector and a microphone connector.
